(19) United States
(12) Patent Application Publication
(10) Pub. No.: US 2007/0226514 A1
(43) Pub. Date: Sep. 27, 2007

(54) Secure biometric processing system and method of use

(75) Inventor: Kerry D. Maletsky, Monument, CO (US)

Correspondence Address: SAWYER LAW GROUP LLP, P O BOX 51418, PALO ALTO, CA, 94303, US

(73) Assignee: ATMEL CORPORATION, San Jose, CA (US)

(21) Appl. No.: 11/603,445

(22) Filed: Nov. 22, 2006

Related U.S. Application Data
(60) Provisional application No. 60/785,870, filed on Mar. 24, 2006.

(51) Int. Cl. H04K 1/00; H04L 9/00

(52) U.S. Cl. 713/186

(57) ABSTRACT

A secure biometric processing system is disclosed. The system comprises a processing system for providing image acquisition and biometric comparison. The processing unit utilizes public key cryptography for handling templates securely and authenticating operations using the template. The system includes a complete biometric engine which implements image reconstruction, template extraction and matching. The secure design of the system combines complete privacy with security, while offering a flexible usage model including on-chip template storage along with encrypted and authenticated communications to the system.

### CROSS REFERENCE TO RELATED APPLICATIONS

Under 35 U.S.C. 119(e), this application claims the benefit of U.S. Provisional Application No. 60/785,870, filed Mar. 24, 2006. This application is also related to co-pending U.S. patent applications filed concurrently herewith, as Attorney Docket No. 3790P, entitled “Method And System For Secure External TPM Password Generation And Use”, Attorney Docket No. 4804P, entitled, “Method And System For Secure External TPM Password Generation And Use”, Attorney Docket No. 3831P, entitled “Secure Biometric Processing System And Method Of Use”, Attorney Docket No. 4069P, entitled, “Secure Biometric Processing System And Method Of Use”, all of which are incorporated herein by reference.

### FIELD OF THE INVENTION

The present invention relates generally to data processing systems and more specifically to a system and method for providing a biometric processing system which is secure.

### BACKGROUND OF THE INVENTION

A biometric sensor is utilized with a processing system to provide a system for authenticating a user. The sensors provide templates to the processing system for authenticating the user. The templates are typically images provided by the sensor. For example, the sensor could be a camera (either a still camera or a video camera), a finger print sensor, a sensor for the iris of an eye or the like. The key element is that the system authenticates the user. Oftentimes these systems are utilized to authenticate the user to allow for another transaction to take place, such as a financial transaction at an automatic teller machine (ATM) or the like. Accordingly, these templates or images must be securely stored and manipulated. This security is provided typically between the sensor and the processing system by providing a private bus therebetween. This is effective when a user is authenticated locally. If the user is being authenticated in a remote location, however, it is harder to authenticate the transaction. Therefore, there must be a way of determining that the person who has been authenticated is actually authorized to use the system in question. Accordingly, what is desired is to provide a system that utilizes biometric information that allows for secure authentication whether locally or remotely. The system should be easy to implement, cost effective and adaptable to existing environments. The present invention addresses such a need.

### SUMMARY OF THE INVENTION

A secure biometric processing system is disclosed. The system comprises a processing system for providing image acquisition and biometric comparison. The processing unit utilizes public key cryptography for handling templates securely and authenticating operations using the template.

The system includes a complete biometric engine which implements image reconstruction, template extraction and matching. The secure design of the system combines complete privacy with security, while offering a flexible usage model including on-chip template storage along with encrypted and authenticated communications to the system.

### BRIEF DESCRIPTION OF THE DRAWINGS

FIG. 1 is a block diagram of a conventional system for utilizing biometric information to authenticate a user.

FIG. 2 is a block diagram of a conventional biometric engine.

FIG. 3 is a simple block diagram of a secure biometric processing unit in accordance with the present invention.

FIG. 4 is one embodiment of a system which utilizes the SBPU in accordance with the present invention.

FIG. 5 is a second embodiment of a system which includes a trusted platform module within the PC which is utilized in conjunction with the SBPU to provide secure authentication.

FIG. 6 is a third embodiment of a system which includes a TPM within the server which is utilized in conjunction with the SBPU.

FIG. 7 is a flow chart of a process for providing a secure authenticated template.

FIG. 8 is a block diagram of a secure biometric processing system in accordance with the present invention.

### DETAILED DESCRIPTION

The present invention relates generally to data processing systems and more specifically to a system and method for providing a biometric processing system which is secure. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

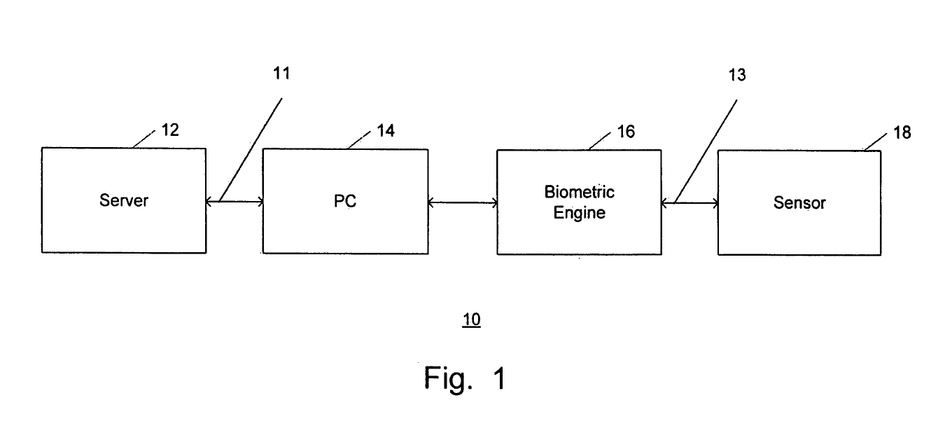

FIG. 1 is a block diagram of a conventional system 12 for utilizing biometric information to authenticate a user. The system 10 comprises a server 12 which communicates with a personal computer 14 via a public bus 11. A biometrics engine 16 is coupled to the personal computer 14. The biometric engine is coupled to a sensor 18 via a private bus 13. As before mentioned, the biometric sensor 18 sends images to the biometric engine 16 via a private bus. The biometric engine 16 extracts templates. The templates must be kept secure over some non-secure portions of the system. Specifically, the templates can be stolen over the public bus 11 from the PC 14 to the server 16 or network. The templates could be located in the server, PC or biometric engine dependent on the environment.

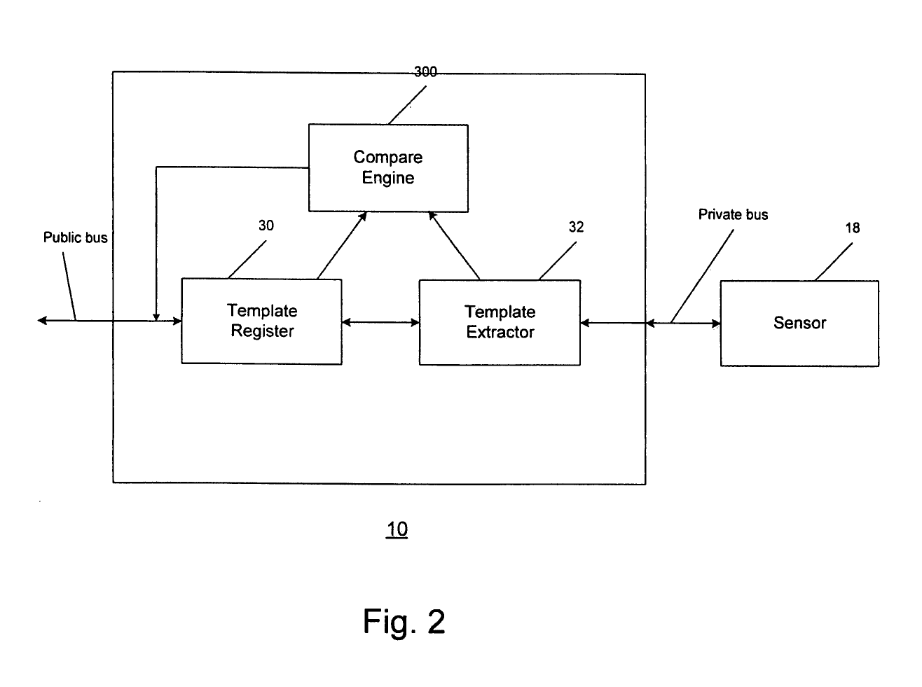

FIG. 2 is a block diagram of a conventional biometric engine 16. The biometric engine 16 is coupled to a sensor by the private bus 11. The biometric engine 16 includes a template register 30, a template attractor 32 and a compare engine 31.

Accordingly, these templates or images must be securely stored, transferred and operated upon. The security and privacy of this system depends solely on the security of the processing system. This is effective when a user is authenticated locally. If the user is being authenticated in a remote location, however, it is harder to authenticate the transaction. Therefore, there must be a way of determining that the person who has been authenticated is actually authorized to use the system in question. Accordingly, what is desired is to provide a system that utilizes biometric information that allows for secure authentication whether locally or remotely.

To address these issues, a secure biometric processing unit in accordance with the present invention is utilized with a sensor. The secure biometric processing unit includes a variety of elements that will be described in detail herein below. The embodiment will be described in the context of a finger chip or finger print sensor. However, one of ordinary skill in the art recognizes that a variety of sensors could be utilized, and that their use would be within the spirit and scope of the present invention.

Accordingly, the biometric sensor could, for example, be an eye sensor or some other sensor that senses a unique portion of the body of a user. To describe the features of the present invention in more detail, refer now to the following description in conjunction with the accompanying figures.

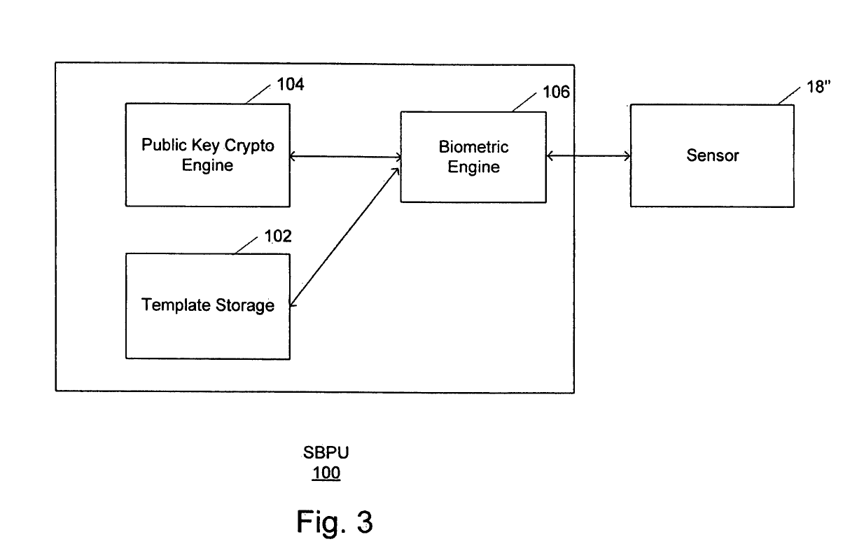

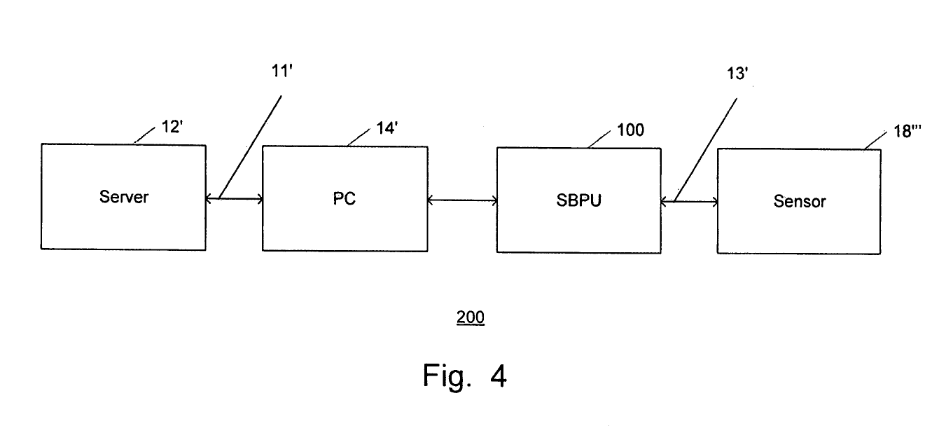

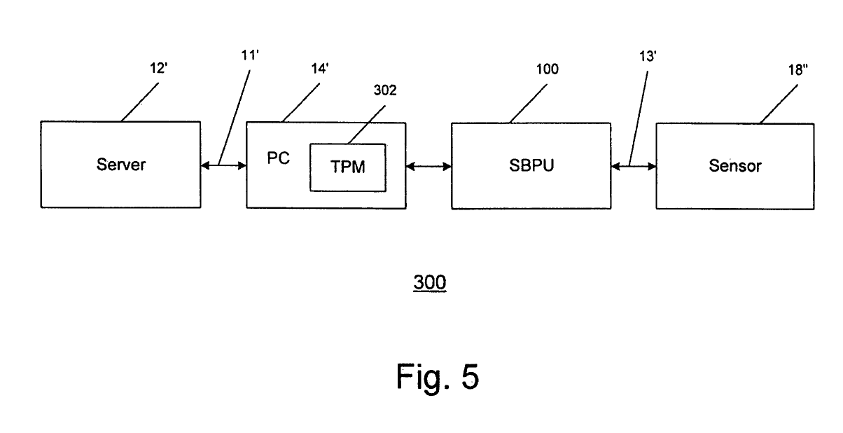

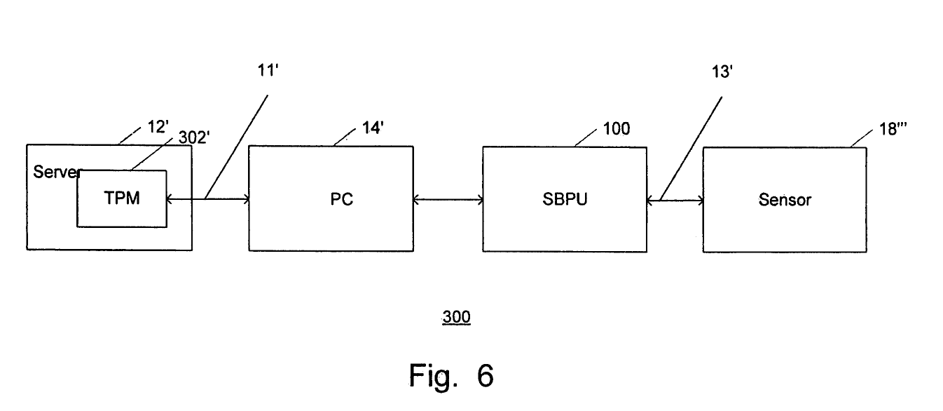

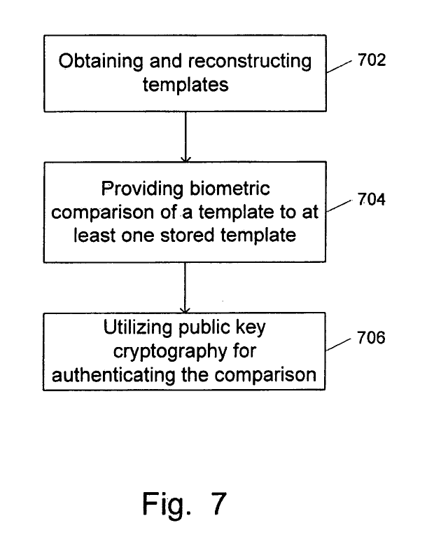

FIG. 3 is a simple block diagram of a secure biometric processing unit (SBPU) 100 in accordance with the present invention. The SBPU 100 is coupled to a sensor 181. The SBPU includes a biometric engine 106 coupled to a cryptographic engine 104 and to storage for the templates. By providing all of these elements on a single chip a more secure system is provided when authenticating a user. To describe the features of the SBPU in a system, refer to the following. FIG. 4 is one embodiment of system 200 which utilizes the SBPU 100 in accordance with the present invention. FIG. 5 is a second embodiment of a system 300 which includes a trusted platform module (TPM) 302 within the PC which is utilized in conjunction with the SBPU to provide secure authentication. FIG. 6 is a third embodiment of a system 300 which includes a TPM 302′ within the server 12′ which is utilized in conjunction with the SBPU 100. FIG. 7 is a flow chart of a process for providing a secure authenticated template. First, an image is obtained and reconstructed, then a template is extracted, via step 702. Next, a biometric comparison of the template to at least one stored template is provided, via step 704. Finally, public key cryptography is utilized for authenticating the comparison, via step 706. To describe how the SBPU is utilized in these different environments to provide secure authentication refer now to the following.

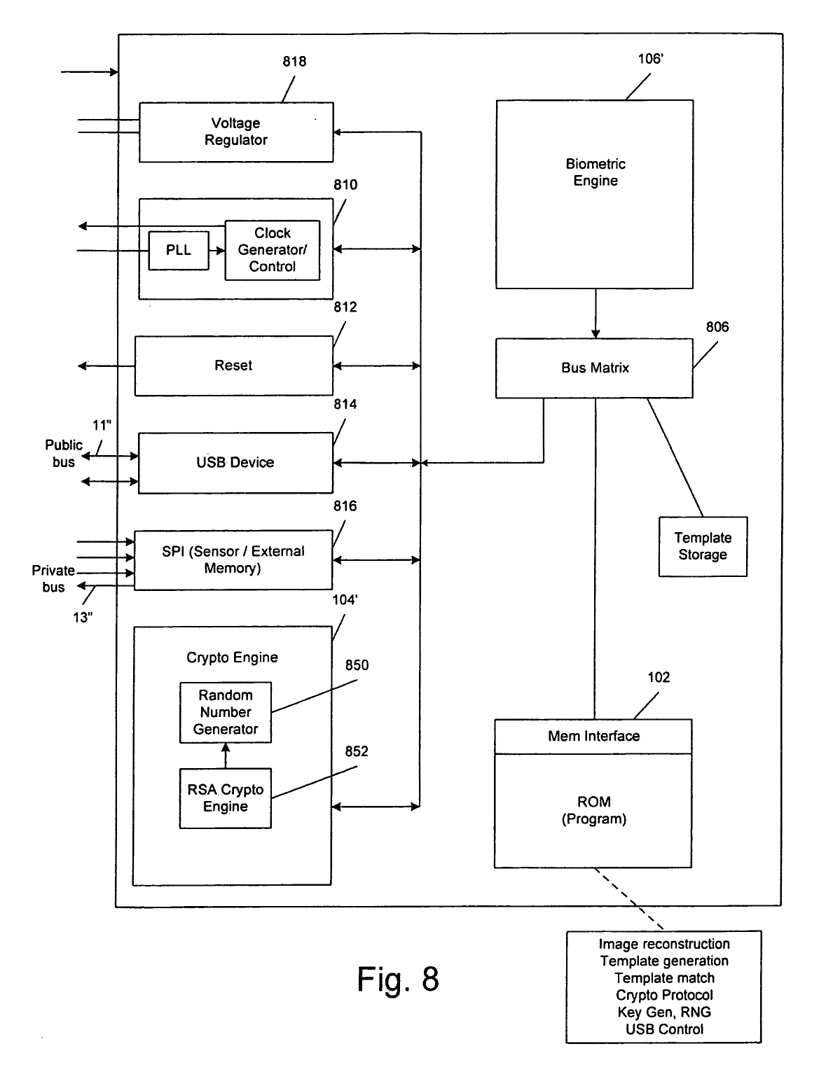

FIG. 8 is a block diagram of a secure biometric processing system 100′ in accordance with the present invention.

The SBPU 100 is, for example, a companion chip to a sensor, for example, the sensor could be an FingerChip sensor manufactured by Atmel Corporation. The SBPU 100 includes a complete biometric engine which implements image reconstruction, template extraction and matching. The secure design of the SBPU 100 combines complete privacy with security, while offering a flexible usage model including on-chip template storage along with encrypted and authenticated communications to the system. In some implementations special hardware features such as a metal shield over circuitry; temperature detectors, voltage detectors, frequency detectors, and light detectors are utilized for security. In addition, a chip may use encrypted internal busses and special test modes to prevent activation in the field. In addition, constant and/or variable execution models can be utilized on the SBPU 100 to thwart security attacks. Finally, attempt counters could be utilized to limit the number of times a hacker can attempt to attack the SBPU 100. Accordingly, a variety of features could be added to chips to provide additional security for the SBPU 100.

Referring to FIG. 8, the secure biometric processing system 100′ comprises a biometric engine 106 coupled by a system bus 804 to a bus matrix 806. The biometric engine 106 in one embodiment is an ARM7 processor designed by ARM Ltd. The bus matrix 806 is coupled to a peripheral bus 802. The bus matrix 806 is also coupled to a memory 102. The memory 102 includes a program which provides the following functions when enabled by the engine 106: template storage, image reconstruction, template generation, template matching, cryptographic protocol, key generation, and USB control. Templates can also be stored in ROM memory template cache 102 or could be stored in an external template cache.

Referring again to FIG. 7, the secure biometric processing system 100′ further comprises a voltage regulator 818, a clock generator 810 coupled to the peripheral bus 802, a reset unit 812, a USB device coupled to a public bus 11″ and to the peripheral bus 802, and interface 814 coupled both to a private bus 13″ for the sensor and to a peripheral bus 608. A public key cryptographic engine 104′ is coupled to the peripheral bus 608. The public key cryptographic engine 104′ includes in one embodiment a random number generator 850 and an RSA cryptographic engine 852 to provide the public key cryptography.

Because of the above comprehensive security model, the software within the SBPU 100 can be the same whether the SBPU 100 is on the motherboard or in a remote stand-alone reader. This feature ensures that application software developed to work in an integrated environment (SBPU 100 integrated on motherboard) will also work without modification in a remote environment (SBPU 100 on stand-alone reader via USB). It further ensures that in a server/client based situation the system model will work seamlessly regardless of the type of the client.

In one embodiment, the processor 106 has sufficient processing capability to reconstruct an image from slices, extract template from a swipe, merge a number of swipes to improve biometric performance and match a new swipe with a previously generated template. Both the SBPU 100 and its command protocol are designed to prevent any software attacks on the biometric data other than direct attacks on the cryptoalgorithms.

In this system template traffic to and from the SBPU 100 is both encrypted and authenticated. Therefore there is no security risk when using an exposed bus like USB. Further, the encryption permits templates to be stored in a variety of places depending on the security policies and requirements of each situation.

Templates can be stored on the SBPU 100 chip itself, on an external memory connected to the SBPU 100 or they can be stored externally and sent to the SBPU 100 at will. By varying the size and/or presence of the external memory the number of templates stored can be varied.

The SBPU 100 includes many of the hardware security features that are found in typical secure chips and systems, which will defend against all but the most determined hardware attacks on the SBPU 100.

There is no encryption on the private bus between the sensor and SBPU 100 so pure hardware attacks are possible during the time when a swipe takes place. It is expected that such attacks would be quite evident to the user who would presumably then take appropriate action. On stand-alone external readers, it is expected that this bus would be physically protected and difficult to attack. Regardless of the implementation, stored templates, secrets and keys cannot be obtained from this bus. To describe records, templates and secrets in more detail refer now to the following description in conjunction with the accompanying figures.

### Definitions

Image—The reconstructed but otherwise unprocessed output of the sensor. It is independent of the biometric engine in use.

Template—extracted information from a fingerprint image that can be compared to the template in a stored record or used to generate a new record. The format and meaning of the template data may be specific to the biometric engine used or may meet some industry standard.

Record—In addition to a set of templates, a record contains identifying information (e.g. name) and connected secrets in an encrypted package that can be stored and loaded for use.

### Records and Templates

Records are the data structures of the SBPU 100 that include the biometric template. In this embodiment, records include a few basic elements:

1. Identification information for the record, in the form of a variable length ‘name’ which identifies the record. In one embodiment, the name or ID number of the individual to whom the record corresponds may be part of the identification information.

2. Various other control values: flags governing usage, biometric parameters such as the type of record (fingerprint, retina, etc) or biometric identifier (right/left, which finger).

3. Biometric template intended to be compared with a new image from a sensor, including sufficient biometric parameters to perform the match operation.

4. Optional secrets to be used after a successful match with the above. Some records may include no secrets, others may include many different ones.

In one embodiment, the identification information and other values and the biometric template are combined to form the Confidential part of the record. Hashes of both confidential and public structure values are carried along with the encrypted package to aid in identification of the record itself and ensure the integrity of the combination of the two parts.

Privacy considerations may mandate the encryption of the identification since it contains a name that could be used to identify the person, but this encryption is optional. Since the confidential information contains not only the biometric data for the person which might be able to be used to ‘clone’ the person but also contains secrets that should not be released unless the person is present, it is always encrypted.

In one embodiment, the biometric data is broken into three sections:

RecordInfo data. Information that may be used by the system software and/or the security layer within the SBPU 100.

BioPublic data. The public portion of the standard biometric template which is passed to the internal SBPU 100 biometric engine, including such information as finger number, biometric engine algorithm in use, biometric engine parameters, etc. This array should not include any actual biometric measurements, all of which should be in the BioPrivate array. (Identifier)

BioPrivate data. Includes the actual biometric template information along with any additional parametric details necessary to permit the biometric engine to perform the appropriate calculation. This information is passed directly to the internal biometric engine without any processing by the security layer in the SBPU 100. Any unique identifying information must be in this structure. (Confidential)

An identifier data structure and a confidential data structure are utilized to contain all the record information.

When a record is passed to the SBPU 100, an authentication data structure is provided.

The data structure authenticates the connection between the various pieces of the record. Preferably, it is computed as the hashed message authentication code (HMAC) of the digests of (1) a clear Identifier structure and (2) a clear Confidential structure.

When stored in the SBPU 100, an organizing data structure may be used to keep the various elements of the record organized and to facilitate use of generated signatures. Because these values may be unique, this organizing data structure should be encrypted using external means if privacy considerations so dictate.

When stored on the SBPU 100, regardless of whether in internal or the connected memory, the format of stored records should be different.

When records are stored within the SBPU 100 (either using the internal memory or connected SPI memory), they are referred to by a handle.

### Record Secrets

Multiple record secrets may be attached to records. The SBPU 100 provides a flexible mechanism to overlay various capabilities on the same secret, or to provide different secrets for each capability.

The secrets fall into two categories, usage secrets and control secrets.

### Usage Secrets

Usage secrets are used or revealed upon a successful swipe. A list of these secrets is provided below.

TpmAuth secret. This is a secret value that will be used to compute an authorization digest for an incoming TPM 302 or SBPU 100 command.

Reveal secret. This is a secret value that will be released in the clear upon a successful match.

HashNonce secret. This is a secret value that can only be sent back to the system hashed with other information. If an observer knows all of the secret values, then he can may be able to determine which hash secret was returned by trying many possibilities.

HashKey secret. This is a secret value that will be hashed with a system key (as well as other nonces) before being sent back to the system on a successful match. Since an observer doesn't know the system key, the observer cannot determine which of many HashKey secrets were returned.

EncryptSecret secret. This is a secret value that will be encrypted before being sent back to the system on a successful match.

### Control Secrets

Knowledge of the value of control secrets is required to perform various operations on the record. Preferably a single secret of each type is permitted within a record. A list of control secrets is provided below.

OpAuth secret. The general authorization required to compare this record with a new swipe. If missing, then comparison does not require authorization. If present, then the Identify operation (search among records) can use this record only if the auth value used for the Identify command matches this value.

ListAuth secret. The authorization required to return the name. If the listRecord command is authorized with this secret, the listName record flag is ignored.

ChangeSecret secret. The authorization required to change this or any other secret within the record. If missing, then changing a secret requires knowledge of its current value.

ValidateSecret secret. The secret that must be in a public key ticket to authorize use of that public key to encrypt outputs of this template.

### Usage Models

### 1. Secure Logon

The SBPU 100 preferably implements the complete image acquisition and biometric comparison processing to simplify BIOS software. If combined with a TPM 302 to validate the BIOS code, the SBPU 100 can provide a range of responses from a simple match/mismatch, to revealed secrets or more complicated cryptographic information.

Windows logon or other user logon mechanisms can take advantage of the same environment, while additionally providing strong protection for the privacy of the user, including defense against replay attacks.

### 2. Protected Transfer of Swipe Image to Server

To support externally implemented biometric software environments (for instance, on a remote server), the SBPU 100 can generate a raw image and securely transfer that to the remote entity. The transferred data is protected against replay (through the use of a nonce from the remote entity) and disclosure (through encryption).

If the biometric engine built into the SBPU 100 is compatible with whatever external system software is being run, then the authentication and/or encryption can also be performed on an extracted template as well.

### 3. Biometric Authorization of TPM Commands

Authorization secrets are required for a number of different things within a TPM 302—for instance, to use or migrate an RSA key from the RSA crypto engine 852 (FIG. 8), to unseal encrypted data or to authorize an owner operation on a TPM 302 (FIG. 5). This secret might be a password, but weaknesses in the password model are well known. With the SBPU 100 the actual TPM 302 secret can be strong (high entropy) and its value can be released only after a successful finger swipe, which adds both security and convenience to the system.

The SBPU 100 will compute the digest for a TPM 302 command and return this to the system. The system then sends this digest along with the TPM 302 command data to the TPM 302. In this manner, the TPM 302 authorization secret never needs to leave the SBPU 100.

### 4. Flexible Template Storage Model

In order to support a secure boot model where disks and the network may be unavailable, some templates must be stored in the SBPU 100. Additional templates may be stored within a BIOS flash memory, on a system disk, on a remote server or on a chip connected directly to the SBPU 100. This facilitates a wide range of security system architectures.

Templates stored off the SBPU 100 are encrypted. The SBPU 100 uses, for example, Advanced Encryption Standard (AES) to permit fast loading and template usage, but keys are backed up and exchanged using RSA for maximum flexibility.

### 5. Seamless Integration with TPM

The SBPU 100 can preferably implement the full TPM 302 key migration mechanism, so RSA keys used for various operations may be seamlessly migrated between the SBPU 100 and the TPM 302. All backup strategies designed for the TPM 302 work identically for the SBPU 100. Like the TPM 302, the SBPU 100 can also generate and use ‘non-migratable’ keys which may have better security properties.

The SBPU 100 also provides key, template and match signatures in an environment similar to that of the TPM 302, including an Endorsement Key (EK) and its certificate.

The SBPU 100 commands are authorized in a manner identical to that of the TPM 302. Tokens (such as smart cards) or external server software that can authorize TPM 302 commands can also authorize SBPU 100 commands, useful in multi-factor authentication schemes.

An external TPM 302 can also compute all of the system-required cryptographic functions that complement the SBPU 100, simplifying and/or securing application code.

### 6. User Identification

The SBPU 100 can compare a fingerprint swipe against a variable number of templates to determine the identity of a user. The templates can be stored within the SBPU 100 (or its connected memory) or they can be stored externally and provided to the SBPU 100 sequentially.

If a matching template is found, identifying information from the template can be signed with an RSA key, a secret value (optionally hashed with a nonce) can be revealed or a TPM 302 command can be authorized.

Of course, the matching operation within the SBPU 100 can be bypassed and the raw image can be encrypted and sent to a remote computer for matching there.

### 7. Secure Enrollment

Because the SBPU 100 can generate and securely transmit a fingerprint image and/or extracted template, an untrusted station can be used to enroll users. Enrollment can also take place locally, and the SBPU 100 owner can control when enrollment is permitted. Either the image or template can be signed by the TPM 302 to verify to the remote server that the image/template was not generated by rogue software.

Since biometric operation may be improved through the combination of several swipes, the SBPU 100 includes the capability to merge a number of templates that have been previously generated.

### 8. Attestation of Physical Presence of a User

When the sensor and SBPU 100 are attached to a system (as in a mobile platform), a successful fingerprint match indicates that the listed user is present in person at a particular system at the current time. Most of the commands include anti-replay mechanisms to ensure that SBPU 100 responses are fresh. This mode of operation corresponds to the physical presence model within the TPM 302 protocol, and is especially effective for delegated owner-authorized commands.

The SBPU 100 can also generate an RSA signature to reliably attest to the physical presence of a given user, which may match some management environments more closely.

To now describe in more detail the commands related to the records and templates, refer now to the following description in conjunction with the accompanying figures.

### SBPU 100 Commands

Commands can be organized into the below identified sections.

Biometric commands. These commands are used to perform biometric operations such as record matching or generation.

Record commands. These commands are used to generate, encrypt and move records on and off the SBPU 100.

USB commands. These commands control the USB communications channel to the host.

RSA Key commands. These commands (similar to TPM 302 commands) are used to control the RSA keys.

Miscellaneous commands. These commands provide a way to initialize and control the SBPU and also provide status.

Examples of for each of the categories of commands are described below. It should be understood that list is not exhaustive. In addition, it should be understood that any combination of these commands could be utilized and that would be within the spirit and scope of the present invention.

### Biometric Commands

GetTemplate commands. A biometric image is generated from a user swipe and processed using the on-board SBPU 100 to generate a template. If image or template quality is poor, the system may change the biometric parameters and rerun the GetTemplate command. The result is stored for later use.

GetImage command. A biometric image is generated from a user swipe, encrypted (along with an input nonce) with the public key presented to the SBPU 100 and passed back to the system. If requested, the image can also be signed with an SBPU 100 RSA key for the RSA crypto engine. If permitted by the manager, clear images can also be sent to the system. After completion of this command the image data is deleted from the SBPU 100.

GenerateRecord command. Data stored in the internal template register is combined with optional secret values which are sent to the SBPU 100 as well as flags and other configuration data sent as inputs to this command. The resulting record is encrypted using the specified parent key and sent back to the system. The public key can be either located within the a key cache or within the SBPU 100 or can be included in the input parameter list.

All secrets are optionally encrypted using a symmetric key that is encrypted with the parent public key and passed to the GenerateRecord command.

MergeRecords command. A variable number of records sent to the SBPU 100 from the system are merged into one using the SBPU 100. All records must have the same parent, same authorization values, etc. The SBPU 100 returns quality information about the merge process.

MatchRecord command. A fingerprint template stored in the template register is compared with a specified record already stored on the SBPU 100 or passed in the input stream. A match is indicated only if the match score exceeds that stored in the record. The result is retained within the SBPU 100 but may also be optionally included in a return code. Normally the command also returns the match score, however if the return code is obfuscated, then score is always returned as zero.

When a record matches the data in the template register some information from the record is retained in the SBPU 100 record register. This register value is overwritten when match data is cleared or a new swipe occurs. In addition to biotype, name and secrets from the record structure, the match score and digests of the identifier and confidential structures are also retained.

If a subsequent MatchRecord command occurs before a new swipe takes place and before the match status is cleared, then the current data in the record register will be replaced with the new record data only if the data in the template register matches the new record the new match score is higher than that stored in the record register. In this way, the external system can implement a user identification procedure using external records.

IdentifyUser command. Searches a range of internally stored records to find one that matches the information in the template register. In the first mode of this command, the SBPU searches for the first record that matches the input image and returns success at that time. In the second mode, IdentifyUser will compare the stored template to every record in the list and keep that match which provides the highest quality. Records are only considered matched if they exceed the threshold score stored in the record itself.

SetParams command. Send biometric engine or sensor parameters to the SBPU 100 unit. Depending on the input mode, these parameters can modify the default values for the SBPU 100 or just the current state. Some parameters are fixed at manufacturing time and can be written a single time only. These parameters do not contain any security information.

GetParams command. Read biometric engine or sensor parameters from the SBPU 100.

TurnOnOff command. Turn on or off the biometric sensor. When off, power consumption may be reduced. When turned on, the default sensor parameters are written to the sensor.

### Record Commands

BindSym command. In one embodiment, two AES symmetric keys are randomly generated, encrypted using a public key that must be already loaded into the SBPU 100 and sent back to the system. One of these keys is intended to be the data obfuscation key SysKey, and is separately encrypted with a public key sent to the SBPU 100.

UnBindSym command. AES symmetric keys are decrypted from an input blob using a key already loaded onto the SBPU 100. Loading of these symmetric keys requires knowledge of the usage authorization value of the parent key, while subsequent usage of the symmetric keys does not require this knowledge. The first symmetric key is used for all subsequent encryption/decryption operations on records attached to this parent, while the second is SysKey, which is used to obfuscate results from the SBPU 100.

LoadRecord command. A record is loaded from the input parameter array into either the on-board nonvolatile record cache or the external nonvolatile memory attached to the SBPU 100 through the private bus.

The input record will be decrypted by the SBPU 100 using the stored symmetric key attached to the parent. If the record is being stored in the external SPI memory it will be re-encrypted before being written to the memory.

ChangeRecord command. Change a secret value stored within a record or add a new secret, requires the knowledge of the appropriate current secret value. Changes can only be made on encrypted records in the input parameter list, but a mode of this command permits multiple records to be serially sent to the SBPU 100 and have the same operation be performed on all records.

All secrets are optionally encrypted using a symmetric key that is encrypted with the parent public key and passed to the ChangeRecord command.

ListRecords command. List handle and recordID for stored records, neither of which contain security and/or identification information. There are three ways to specify which records to list: all records, default records and a single specified record. The command returns an array of handle/RecordID pairs.

ListRecordComplete command. List the identifying information for the record, in the form of a ListRecordComplete structure. If the record flags indicate that authorization is required to release the unique and identifying information, then the appropriate secret must be use to authorize the command.

Evict command. A record is deleted from one of the storage locations.

AuthorizeTPM command. If a MatchRecord or IdentifyUser command has returned true, then a TPM 302 authorization secret stored within the record will be used to generate an authDigest for a TPM 302 command summary sent to the SBPU 100. The resulting digest is returned to the system. The match status is optionally reset after the execution of this command.

### Nonces and Anti-Replay

The SBPU 100 provides a number of mechanisms to ensure that responses are unique:

Commands can be authorized, which requires knowledge of a secret attached to a template or the manager authorization secret. Authorization sessions include a pair of one time random nonces that both the input and output.

Startup generates two random numbers: BootSessionID and PowerSessionID. These identify both the SBPU 100 device and provide some temporal connection between events.

Swipe nonce command. The system sends the SBPU 100 a random number when the swipe happens. Inclusion of this nonce in the later result command output connects the swipe operation and the result operation.

Input nonce from the system command. The system sends another nonce at the time the result command is executed. This nonce is present to prevent replay.

Record secret. The anti-replay digest can also include a secret (HashNonce or HashSecret) stored with the record, which connects the operation to a record and which also hides the record information from all observers.

Once all secret structures have been concatenated, a digest of this string is generated and the result is used as the key. In this manner, for instance, the name can be hashed with a secret and sent to the system via the antiReplay digest. If secretFlag is set to 0 on input, then the key is a string of 20 0's.

Where secretFlag specifies a TpmAuth value, then the data inserted in the string is the output TPM 302 authorization digest and not the TPM 302 secret itself. This is necessary because there may be no external entity which has the secret TPM 302 auth value.

If the secretFlag specifies a HashKey, then SysKey must also be specified in the secretFlag.

For digests which contain only values which are revealed in the output stream (Name, RecordID TpmAuth or RevealSecrets), the antiReplay digest does not provide proof that the SBPU actually computed the digest, as an attacker can intercept the output and change/create the antiReplay digest. The same is true when secretFlag is 0. Where there is some trust in the software and/or IO channel, then these digests may be more useful.

The system also receives an antiReplay digest of the nonce information, computed as per the Nonces and AntiReplay section above. This is most useful if hashNonce and TPMauth are specified in the secretFlag input.

SignMatch command. Generates a signature of the most recent match, including an input nonce, the swipe nonce, the match score and digests of the identifier and confidential structures from the record which was matched. This must be the only command to use a particular match status (i.e. neither AuthorizeCommand nor ReleaseSecret can be run on this match) and the match status is automatically reset after SignMatch.

If return values are NOT obfuscated, then the output also includes clear text copies of the record information that was signed.

ReleaseSecret command. If a MatchRecord or IdentifyUser command has returned true, then the specified information stored in the record will be sent back to the system in one or two formats. The information can be one of the following:

1. A Reveal, HashNonce or HashKey secret stored in the record.

2. The Name value stored in the record.

3. The RecordID value stored in the record.

The system always receives the antiReplay digest of the information, computed as per the Nonces and AntiReplay section above. If the information includes a ‘Reveal’ secret, the name (and the RevealName flag is set) and/or RecordID, then the clear text information is returned along with the digest.

The match status is optionally reset after the execution of this command.

The simplified version below returns a single secret only.

ReleaseEncrypt command. If a MatchRecord or IdentifyUser command has returned true, then the specified information stored in the record will be encrypted and sent back to the system. In most other ways, this command is similar to ReleaseSecret, including the return of the anti-replay digest. There are two sources for the encryption key:

A. The information can be encrypted with a public key included in the input. Also in the input must be a ticket authorizing the public key for use in this situation.

B. The information can be symmetrically AES encrypted with SysKey.

SignRecord command. Digest of the clear Identifier and Confidential structures associated with the record specified are signed with an RSA key. If the record is associated with a non-migratable parent key, then the recipient of the signature can be sure that the record was generated on this SBPU and can be known nowhere else. Combined with the SignMatch command, this capability can be used to show that a user is physically present.

SetDefaultRecord command. Store in EEPROM a default list of records to be used by the SBPU during operations (such as BIOS login) when the software does not have the information necessary to specify particular record handles. If the MatchRecord command specifies the default, then the first record in this list is used. Records referenced in this list cannot be removed from the SBPU 100 without manager authorization. This command is manager authorized.

### USB Operations Commands

AbortSwipe command. Can be sent to the SBPU 100 after a GetTemplate or GetImage command. The operation of these commands depends on user action which may take an arbitrary amount of time. When one of these commands is aborted, they return an error code indicating that fact.

### RSA Key Commands

CreateWrapKey command. Create either a signing or encrypting RSA key, encrypt it with a parent stored on the SBPU 100 and send the result to the system. Note that this command uses symmetric encryption for the authorization secrets.

LoadKey command. Load an RSA key into the key cache in the SBPU 100. The key must have been encrypted with an RSA parent, and may be the result of a CreateWrapKey command.

ChangeAuth command. Change the authorization value for an RSA key. The input is an encrypted key and the output goes back to the system. Note that this command uses symmetric encryption for the authorization secrets.

GetPubKey command. Returns the public portion of a key stored in the SBPU 100. Usually requires some sort of authorization for privacy reasons.

Evict command. Evict a key from the cache in the SBPU 100.

AuthorizeMigrationKey command. The manager can create a ticket which permits a public key to be used in the future to migrate RSA keys in the SBPU 100.

CreateMigrationBlob command. If the migration authorization secret is known, encrypt a key with a new authorization parent and send to the system.

ConvertMigrationBlob command. Converts a blob from a TPM 302 or SBPU 100 into a legal SBPU 100 key input package which can be loaded with LoadKey.

CertifyKey command. Using a key stored in the SBPU 100, sign a digest of the public key plus properties of another key on the SBPU 100. The signing key may be the EK.

MakeIdentity command. Generates a signing key that is anonymously connected to the EK (and its certificate) through an external certificate authority (CA).

ActivateIdentity command. The mate to MakeIdentity, uses information back from the CA to enable the key to be used by the SBPU 100.

### Miscellaneous Commands

Startup command. Optionally initialize the SBPU 100 after a power cycle operation. There are three modes to this command:

Boot command. The SBPU 100 will initialize its internal parameters and generate a random number that will be assigned to this boot session and which will be saved in nonvolatile memory.

Wake command. The SBPU 100 will initialize its internal parameters, clear out all registers and delete the saved state. The boot session ID stored in nonvolatile memory will be unchanged.

Restore command. If there is valid internally saved state and the boot session ID stored with the saved data matches that stored in the normal boot session nonvolatile memory, then the registers will be loaded from the saved state and the saved data will be deleted.

If this command is not run but another command is sent to the SBPU immediately after power-up, then the SBPU 100 will automatically run Startup (Wake). Startup can be run only once per power cycle.

SaveState command. Save the boot session, swipeNonce, template and record register values in nonvolatile memory. If any of these values are modified after the SaveState command has been run, then the nonvolatile storage is invalidates. SaveState can be run only once per boot cycle.

GetCapabilities command. Returns various information about the SBPU 100, such as the number of key and record slots, version, etc. This command does not return any security or privacy sensitive information.

SetCapabilities command. Configures various policies or states of the SBPU 100. This command is always manager authorized.

1. Enable/disable SBPU 100. When disabled, most commands return error.

2. Permit clear images to be sent to the system.

3. Permit image acquisition.

4. Permit record generation.

5. Permit SaveState operation.

AuthorizePubkey command. Generates a ticket that designates a particular public key as trusted for use with various SBPU 100 commands. This public key is usually an encryption key for a remote. The resulting ticket must be saved on the system and passed to the SBPU 100 with each use. See Public Key Ticket section above.

GetRandom command. Returns a variable length random number.

OpenAuth command. Returns a random nonce that starts an initialization chain to be used for SBPU 100 commands. (Similar to OIAP in the TPM 302 spec.) The SBPU 100 can accommodate two nonce chains at the same time.

CloseAuth command. Ends the specified authorization chain. Certain commands also end the chain, and the chain is automatically terminated on an authorization error.

CreateEndorsementKey command. Generate the unique endorsement signing key for this SBPU 100. Can be run once only.

WriteEndorsementSig command. Write the endorsement signature and digest of the signing public key to the SBPU 100 nonvolatile memory. This command can be run once only.

ReadEndorsementSig command. Read the endorsement signature stored on the SBPU 100. This command can be run multiple times, but requires manager authorization.

Initialize SBPU command. Generates the root storage encryption key for the RSA key cache, sets the manager authorization value, and prepares the SBPU 100 for use. Generally run once for every new owner of the SBPU 100 hardware.

Clear SBPU command. Deletes all information stored in the SBPU 100 and any attached memory, including keys, records, authorization values, configuration, etc. The next step must be Initialize SBPU 100.

ChangeMgrAuth command. Changes the current value of the manager authorization secret.

To describe in more detail the commands related to the records and templates, refer now to the following description in conjunction with the accompanying figures.

### Record Encryption

Records can be encrypted using, for example, Advanced Encryption Standard (AES). The AES keys used for this encryption are attached to RSA parent encryption keys and their values are encrypted using the parent's public key. This mechanism allows fast record loading and unloading, while preserving the signature, external generation, migration and usage control features of an RSA key hierarchy.

The SBPU 100 can attach a single AES key to each RSA encryption key, though the system must separately load the RSA and then the AES key values. These AES keys are stored in nonvolatile memory within the SBPU 100 alongside the RSA key information, and are automatically unloaded when the RSA key is unloaded.

The BindSym and UnBindSym commands are used to pass the AES encryption key to and from the SBPU 100. If the parent key is migratable, then the operation is similar to the TPM 302 commands Bind and Unbind, with the exception that the parent's migration auth is encrypted along with the symmetric key. The inclusion of the migration authorization value prevents an external entity from generating a fraudulent encryption key.

If the parent key is non-migratable then an SBPU_proof value is included in the encrypted blob generated by the BindSym command, and the operation is similar to the TPM 302 commands Seal and UnSeal. Unlike TPM_Seal/UnSeal, there are no PCRs and there is no stored authorization information within the encrypted blob. If such authorization information is desired, it can be included as part of the parent key authorization.

SBPU_proof is a set of random secrets generated once at initialization time which can never be known outside the SBPU 100. The SBPU 100 generates different proof values for different size parent keys. Non-migratable keys must have a non-migratable parent key. Parent keys can be any length and can have children keys which have a key length less than or equal to the key length of the parent.

Though records are attached to public keys, they are stored separately from their parents and are not unloaded from the SBPU 100 when their parents are. The record flags may be set such that the parent key must be present in the SBPU 100 for the record to be used—this facility may be used to prevent usage of records in an environment where a particular parent key cannot be loaded. A usage example might be user keys in a multi-user system.

### Public Key Ticket

Commands that require a public key within the input parameter list also require a ticket that authorizes this public key for the specified use. This prevents an attacker from sending a rogue public key to the SBPU 100 to circumvent the security profiles.

The GenerateTemplate command can either encrypt its template using a symmetric key to have been previously loaded into the SBPU 100 (using UnBindSym) or can use a public key/ticket.

In general, the ticket takes the form of a hash of the public key with some other critical information. There are three separate sections to this extra information:

Which operations are being authorized?

The source of the secret used to generate the ticket.

The template to which this ticket may be optionally attached.

Specifically, the ticket contains an HMAC of a TicketData structure with the specified secret used as the key. The TicketData structure is included with the ticket, the SBPU 100 recomputes the digest using its internally stored secret and accepts the public key if the digests match. Normally, the public key and ticket are passed to the SBPU 100 together.

The SBPU includes a complete biometric engine which implements image reconstruction, template extraction and matching. The secure design of the SBPU combines complete privacy with security, while offering a flexible usage model including on-chip template storage along with encrypted and authenticated communications to the system. Accordingly, the SBPU can be utilized in a variety of environments to allow for secure authentication of a user, of a personal computer or the like.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A device comprising:
a processing system for providing template acquisition, and biometric comparison; wherein the processing system utilizes public key cryptography for handling templates securely.

2. The device of claim 1 wherein template operations are authenticated, utilizing public keys.

3. The device of claim 1 wherein a portion of the templates to be compared are stored on the device.

4. The device of claim 1 wherein the processing system comprises a biometric engine for acquiring and comparing templates; a storage mechanism coupled to the biometric engine for storing the templates and a public key cryptography engine coupled to the storage mechanism and the biometric engine for providing secure transfer and usage of templates.

5. The device of claim 4 wherein the storage mechanism comprise a cache.

6. The device of claim 4 wherein the storage mechanism comprises a memory.

7. The device of claim 1 wherein the public key cryptography is utilized for authenticating the biometric comparison.

8. The device of claim 1 wherein an identical public key on a trusted platform module (TPM) is utilized to allow authentication of the templates.

9. The device of claim 1 wherein identical public keys are transferred between a trusted platform module (TPM) and the device.

10. The device of claim 1 wherein public key cryptography is utilized for securely transferring templates to and from the device to another system.

11. The device of claim 1 wherein public key cryptography is utilized to provide backup templates to be restored on a replacement device.

12. The device of claim 1 wherein an arbitrary number of secrets can be attached to the template.

13. The device of claim 12 wherein use of the secrets can be restricted individually to various specified operations.

14. The device of claim 1 wherein multiple secrets are used within a single validation step to improve security and/or functionality.

15. The device of claim 1 wherein secrets are utilized to authorize a TPM command.

16. The device of claim 1 wherein one or more security secrets can be hashed with a separate system secret to prevent external entities from determining the value of one or more template secrets.

17. The device of claim 1 wherein special hardware features are within the system to provide additional security.

18. The device of claim 17 wherein the special hardware features comprise any and any combination of, a metal shield to protect the device, temperature detectors, voltage detectors, frequency detectors, light detectors, encrypted internal busses, special test modes to prevent activation, valuable execution models to minimize security attacks and attempt counters to limit the number of attacks on the device.

19. A system comprising:
a device including a processing unit for providing image acquisition and biometric comparison; wherein the processing unit utilizes public cryptography for handling templates securely; and
a trusted platform module (TPM) in communication with the processing unit.

20. The system of claim 19 wherein the TPM is within a second device.

21. The system of claim 20 wherein the second device comprises any of a personal computer server, PDA, cell phone, laptop, and notebook or other embedded processing unit.

22. The system of claim 20 wherein a portion of the templates to be compared are stored on the device.

23. The system of claim 20 wherein template operations are authenticated utilizing the public keys.

24. The system of claim 20 wherein the templates are stored externally.

25. The system of claim 20 wherein the public key cryptography is utilized for authenticating the biometric comparison.

26. The system of claim 19 wherein an identical public key on a trusted platform module (TPM) is utilized to allow authentication of the templates for operations.

27. The system of claim 20 wherein identical public keys are transferred between a trusted platform module (TPM) and the device.

28. The system of claim 19 wherein public key cryptography is utilized for securely transferring templates to and from the device to another system.

29. The system of claim 19 wherein public key cryptography is utilized to provide backup templates to be restored on a replacement device.

30. The system of claim 19 wherein an arbitrary number of secrets can be attached to the template.

31. The system of claim 30 wherein use of the secrets can be restricted individually to various specified operations.

32. The system of claim 19 wherein multiple secrets are used within a single validation step to improve security and/or functionality.

33. The system of claim 19 wherein secrets are utilized to authorize a TPM command.

34. The system of claim 19 wherein one or more security secrets can be hashed with a separate system secret to prevent external entities from determining the value of one or more template secrets.

35. The device of claim 19 wherein special hardware features are within the system to provide additional security.

36. The device of claim 35 wherein the special hardware features comprise any and any combination of, a metal shield to protect the device, temperature detectors, voltage detectors, frequency detectors, light detectors, encrypted internal busses, special test modes to prevent activation, valuable execution models to minimize security attacks and attempt counters to limit the number of attacks on the device.
